(19) United States
(12) Patent Application Publication
(10) Pub. No.: US 2008/0074210 A1
(43) Pub. Date: Mar. 27, 2008

(54) Signal splitter

(75) Inventors: Yung-Sheng Chen, Kaohsiung County (TW); Wen-Chung Liu, Kaohsiung County (TW)

Correspondence Address: GALLAGHER & LATHROP, A PROFESSIONAL CORPORATION, 601 CALIFORNIA ST, SUITE 1111, SAN FRANCISCO, CA, 94108, US

(73) Assignee: YCL Electronics Co., Ltd., Feng Shan City (TW)

(21) Appl. No.: 11/518,009

(22) Filed: Sep. 8, 2006

(51) Int. Cl. H01P 5/12

(52) U.S. Cl. 333/124

(57) ABSTRACT

A signal splitter includes a common mode choke circuit that includes a first choke coil having two input nodes coupled to an incoming telephone line, and two output nodes coupled respectively to two first input nodes of a first filter inductor of a first filter circuit, and a second choke coil having two input nodes coupled respectively to two second output nodes of a second filter inductor of a third filter circuit, and two output nodes coupled to a telephony instrument. A second filter circuit includes a first capacitor coupled between two first output nodes of the first filter inductor that are coupled respectively to two second input nodes of the second filter inductor. The third filter circuit further includes a second capacitor coupled between the second output nodes of the second filter inductor.

### BACKGROUND OF THE INVENTION

1. Field of the Invention

The invention relates to a signal splitter, more particularly to a signal splitter capable of effectively suppressing common mode noise from an incoming signal in an incoming telephone line.

2. Description of the Related Art

In an ADSL (Asymmetric Digital Subscriber Line) system, telephony and data signals can be transferred at the same time on a common telephone line.

In the traditional ADSL technology, a conventional signal splitter is coupled among an incoming telephone line, a telephony instrument, such as a telephone set, and a networking interface unit, such as an ADSL modem. The conventional signal splitter includes a low-pass filter for permitting a voice signal, i.e., a low-frequency component having a frequency ranging from 0 to 4 KHz, of an incoming signal in the incoming telephone line to pass therethrough to the telephony instrument. However, common mode noise from the incoming signal in the incoming telephone line cannot be effectively suppressed, thereby resulting in unstable impedance matching characteristics.

### SUMMARY OF THE INVENTION

Therefore, the object of the present invention is to provide a signal splitter that can overcome the aforesaid drawbacks of the prior art.

According to the present invention, a signal splitter comprises:

a first filter circuit including a first filter inductor that has a pair of first input nodes adapted to be coupled to an incoming telephone line, and a pair of first output nodes;

a second filter circuit including a first capacitor coupled between the first output nodes of the first filter inductor;

a third filter circuit including
a second filter inductor that has a pair of second input nodes coupled respectively to the first output nodes of the first filter inductor, and a pair of second output nodes, and
a second capacitor coupled between the second output nodes of the second filter inductor; and

a common mode choke circuit including
a first choke coil having a pair of input nodes adapted to be coupled to the incoming telephone line, and a pair of output nodes coupled respectively to the first input nodes of the first filter inductor, thereby permitting coupling of the first input nodes of the first filter inductor to the incoming telephone line, and
a second choke coil having a pair of input nodes coupled respectively to the second output nodes of the second filter inductor, and a pair of output nodes adapted to be coupled to a telephony instrument.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic electrical circuit diagram illustrating the first preferred embodiment of a signal splitter according to the present invention; and

FIG. 2 is a schematic electrical circuit diagram illustrating the second preferred embodiment of a signal splitter according to the present invention.

### DETAILED DESCRIPTION OF THE PREFERRED EMBODIMENTS

Before the present invention is described in greater detail, it should be noted that like elements are denoted by the same reference numerals throughout the disclosure.

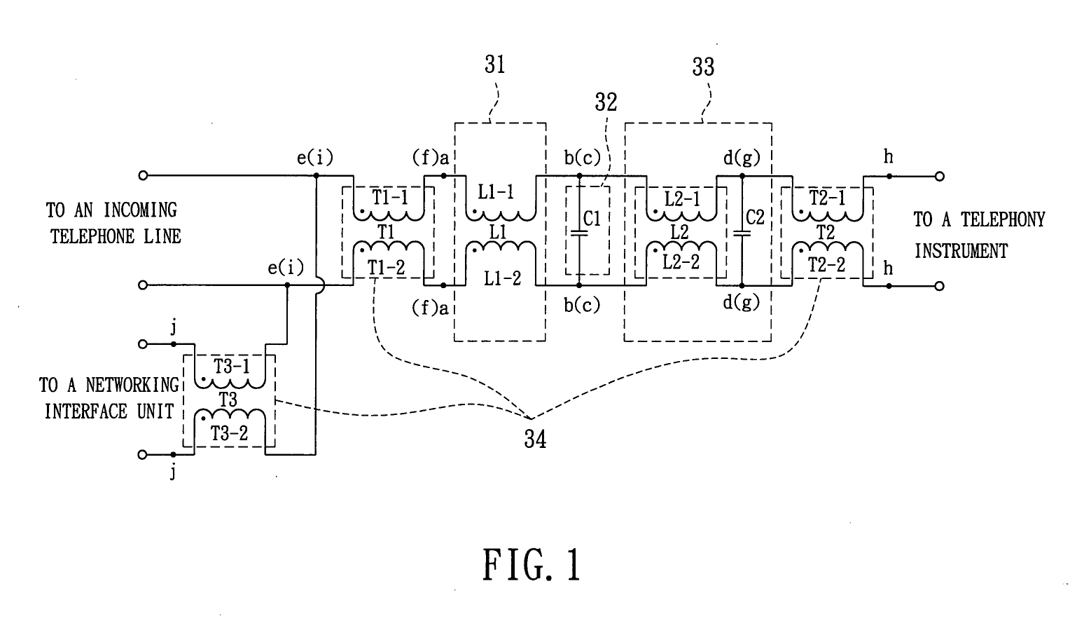

Referring to FIG. 1, the first preferred embodiment of a signal splitter according to the present invention is shown to include a first filter circuit 31, a second filter circuit 32, a third filter circuit 33, and a common mode choke circuit 34.

The first filter circuit 31 includes a first filter inductor (L1) that has a pair of first input nodes (a) adapted to be coupled to an incoming telephone line, and a pair of first output nodes (b). In this embodiment, the first filter inductor (L1) includes a common core (not shown), and two mutually inductive windings (L1-1, L1-2) wound on the common core.

The second filter circuit 32 includes a first capacitor (C1) coupled between the first output nodes (b) of the first filter inductor (L1).

The third filter circuit 33 includes a second filter inductor (L2) and a second capacitor (C2). The second filter inductor (L2) has a pair of second input nodes (c) coupled respectively to the first output nodes (b) of the first filter inductor (L1), and a pair of second output nodes (d). In this embodiment, the second filter inductor (L2) includes a common core (not shown), and two mutually inductive windings (L2-1, L2-2) wound on the common core. The second capacitor (C2) is coupled between the second output nodes (d) of the second filter inductor (L2).

In this embodiment, the common mode choke circuit 34 includes first to third choke coils (T1, T2, T3). The first choke coil (T1) has a pair of input nodes (e) adapted to be coupled to the incoming telephone line, and a pair of output nodes (f) coupled respectively to the first input nodes (a) of the first filter inductor (L1), thereby permitting coupling of the first input nodes (a) of the first filter inductor (L1) to the incoming telephone line. The first choke coil (T1) includes a common core (not shown), and two mutually inductive windings (T1-1, T1-2) wound on the common core. The second choke coil (T2) has a pair of input nodes (g) coupled respectively to the second output nodes (d) of the second filter inductor (L2), and a pair of output nodes (h) adapted to be coupled to a telephone instrument, such as a telephone set. The second choke coil (T2) includes a common core (not shown), and two mutually inductive windings (T2-1, T2-2) wound on the common core. The third choke coil (T3) has a pair of input nodes (i) adapted to be coupled to the incoming telephone line, and a pair of output nodes (j) adapted to be coupled to a networking interface unit, such as an ADSL modem. The third choke coil (T3) includes a common core (not shown), and two mutually inductive windings (T3-1, T3-2) wound on the common core.

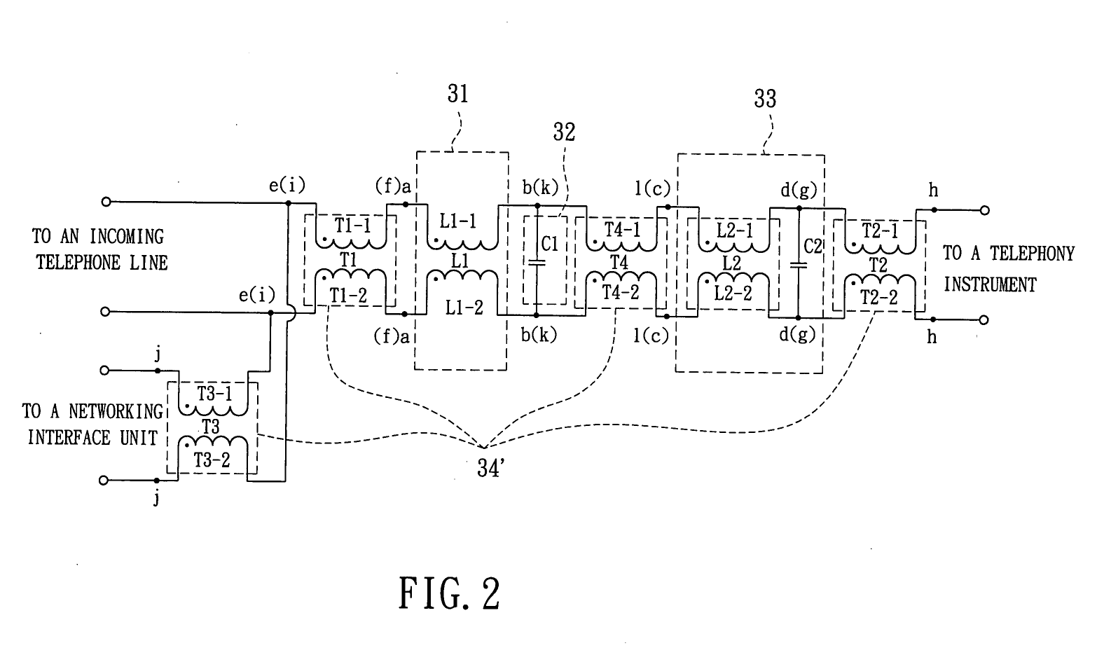

FIG. 2 illustrates the second preferred embodiment of a signal splitter according to this invention, which is a modification of the first preferred embodiment. Unlike the previous embodiment, the common mode choke circuit 34′ further includes a fourth choke coil (T4) that has a pair of input nodes (k) coupled respectively to the first output nodes (b) of the first filter inductor (L1), and a pair of output nodes (1) coupled respectively to the second input nodes (c) of the second filter inductor (L2) such that the second input nodes (c) of the second filter inductor (L2) are coupled to the first output nodes (b) of the first filter inductor (L1) via the fourth choke coil (T4). In this embodiment, the fourth choke coil (T4) includes a common core (not shown), and two mutually inductive windings (T4-1, T4-2) wound on the common core.

In sum, due to the presence of the common mode choke circuit 34, 34′, the common mode noise from the incoming signal in the incoming telephone line can be effectively suppressed, thereby resulting in stable impedance matching characteristics.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A signal splitter comprising:
a first filter circuit including a first filter inductor that has a pair of first input nodes adapted to be coupled to an incoming telephone line, and a pair of first output nodes;
a second filter circuit including a first capacitor coupled between said first output nodes of said first filter inductor;
a third filter circuit including
a second filter inductor that has a pair of second input nodes coupled respectively to said first output nodes of said first filter inductor, and a pair of second output nodes, and
a second capacitor coupled between said second output nodes of said second filter inductor; and
a common mode choke circuit including
a first choke coil having a pair of input nodes adapted to be coupled to the incoming telephone line, and a pair of output nodes coupled respectively to said first input nodes of said first filter inductor, thereby permitting coupling of said first input nodes of said first filter inductor to the incoming telephone line, and
a second choke coil having a pair of input nodes coupled respectively to said second output nodes of said second filter inductor, and a pair of output nodes adapted to be coupled to a telephony instrument.

2. The signal splitter as claimed in claim 1, wherein at least one of said first and second filter inductors, and said first and second choke coils includes a common core, and two mutually inductive windings wound on said common core.

3. The signal splitter as claimed in claim 1, wherein said common mode choke circuit further includes a third choke coil having a pair of input nodes adapted to be coupled to the incoming telephone line, and a pair of output nodes adapted to be coupled to a networking interface unit.

4. The signal splitter as claimed in claim 3, wherein said third choke coil includes a common core, and two mutually inductive windings wound on said common core.

5. The signal splitter as claimed in claim 1, wherein said common mode choke circuit further includes a fourth choke coil having a pair of input nodes coupled respectively to said first output nodes of said first filter inductor, and a pair of output nodes coupled respectively to said second input nodes of said second filter inductor such that said second input nodes of said second filter inductor are coupled to said first output nodes of said first filter inductor via said fourth choke coil.

6. The signal splitter as claimed in claim 5, wherein said fourth choke coil includes a common core, and two mutually inductive windings wound on said common core.
